(19) United States
(12) Patent Application Publication
(10) Pub. No.: US 2024/0096512 A1
(43) Pub. Date: Mar. 21, 2024

(54) METHOD FOR PERFORMING STAR/ARWV RECONCILIATION

(71) Applicant: Westinghouse Electric Company LLC, Cranberry Township, PA (US)

(72) Inventor: Jeffery A. BROWN, Butler, PA (US)

(73) Assignee: Westinghouse Electric Company LLC, Cranberry Township, PA (US)

(21) Appl. No.: 17/930,909

(22) Filed: Sep. 9, 2022

(51) Int. Cl. G21D 3/00; G21C 7/36

(52) U.S. Cl. CPC G21D 3/001; G21C 7/36

(57) ABSTRACT

A method for transitioning a nuclear reactor during initial cycle startup to a power generating state is disclosed. The method includes setting the nuclear reactor to a zero power state, eliminating lower power physics tests (LPPTs) for a current cycle of the nuclear reactor based on a predetermined set of criteria, and setting the nuclear reactor to the power generating mode without performing the LPPTs, based on the reconciliation. The eliminating includes predicting, using a first design code, a first set of values for factors of the LPPTs, developing, using data from past cycles of the nuclear reactor, empirical formulas for the factors of the LPPTs, predicting, using the empirical formulas, a second set of values for the factors of the LPPTs, and reconciling the first values with the second values.

### BACKGROUND

This invention relates generally to a method of reducing startup testing time that is required prior to transitioning a nuclear reactor during initial cycle startup to a power generating state.

### BRIEF DESCRIPTION OF THE DRAWINGS

Various features of the embodiments described herein, together with advantages thereof, may be understood in accordance with the following description taken in conjunction with the accompanying drawings as follows:

FIG. 1 illustrates a method for transitioning a nuclear reactor during initial cycle startup to a power generating state, according to at least one aspect of the present disclosure.

Corresponding reference characters indicate corresponding parts throughout the several views. The exemplifications set out herein illustrate various embodiments of the invention, in one form, and such exemplifications are not to be construed as limiting the scope of the invention in any manner.

### DETAILED DESCRIPTION

Numerous specific details are set forth to provide a thorough understanding of the overall structure, function, manufacture, and use of the embodiments as described in the specification and illustrated in the accompanying drawings. Well-known operations, components, and elements have not been described in detail so as not to obscure the embodiments described in the specification. The reader will understand that the embodiments described and illustrated herein are non-limiting examples, and thus it can be appreciated that the specific structural and functional details disclosed herein may be representative and illustrative. Variations and changes thereto may be made without departing from the scope of the claims.

When setting a nuclear generating plant to a power generating state, it is required that certain tests, such as lower power physics tests (“LPPT”), be performed. These tests are performed under non-standard plant operating conditions, thus resulting in increased risk of a plant trip or incorrect test result. In 2019, the Pressurized Water Reactor Group (“PWROG”) initiated an industry wide effort to reduce startup testing time in order to support a faster return to the power generating state.

CE-NSSS plants accomplished this initiative in 2005 using the NRC-approved Startup Test Activity Reduction (“STAR”) program, which allows for the elimination of LPPT measurements of rod worth and hot zero power (“HZP”) moderator temperature coefficient (“MTC”). The STAR method requires that STAR Applicability Requirements, which can be seen in Table 3-4 of WCAP-16011-P-A, “Startup Test Activity Reduction Program”, February 2005, which is hereby incorporated by reference in its entirety herein, be evaluated each cycle to confirm that the cycle meets all the requirements to justify elimination of these LPPT tests.

While utilities have developed their own justifications for rod worth elimination, only the Westinghouse Alternate Rod Worth Verification (ARWV) method, which is closely based on the NRC approved STAR methodology, is fully compliant with the current W-NSSS safety analysis methodologies.

Both the current STAR and ARWV methodologies require that a second qualified method, using an independent, alternate method that has been benchmarked to plant measurements, be used for predicting the HZP rod worth and (for STAR) MTC and then compared (reconciled) with the design code prediction. The inclusion of the reconciliation of design code predictions with an independent, alternate prediction provides a good (and perhaps even better) alternative to verification by actual measurements.

The current approach for doing this uses a prediction by a second design qualified neutronics code. This approach requires that the second code be maintained for every unit and cycle. However, maintaining this second code requires non-trivial man-time and has undesirable costs associated therewith. This aspect has been a major impediment for W-NSSS plants adopting the ARWV method for rod worth test elimination. Furthermore, it has also resulted in dissatisfaction among the CE-NSSS plants using the STAR methodology.

As one example, design code predictions from the Westinghouse code ANC are currently compared to predictions using the independent, alternative NRC approved design code as both have been benchmarked to plant measurements. However, this method requires that the alternate design code be maintained and updated each cycle for perhaps no other reason than to use for STAR reconciliation.

Accordingly, there is a need to develop an easier to utilize, independent alternate prediction to reconcile with the cycle specific predictions to justify elimination of the LPPTs during plant startup.

The STAR topical does allow an alternate means of performing the reconciliation involving extrapolation of previous measurements to current cycle conditions. The STAR topical requires that this extrapolation consider changes in power distribution, core average enrichment, amount and type of burnable absorber, reactor coolant system (“RCS”) boron concentration and moderator temperature for the extrapolation of control element assembly (“CEA”) worth.

Consideration of changes in RCS boron concentration, amount and type of burnable absorber, moderator temperature, core leakage, and core average enrichment are required for the extrapolation of MTC. The STAR topical limits use of the extrapolation method for reconciliation to cycles that have characteristics relative to the measured cycles that are within the Core Design Applicability Requirement #3 of Table 3-4 of WCAP-16011-P-A, have water to fuel metal ratio within ±2%, have the same fuel pin pitch, and have the same fuel management style (i.e., low leakage).

The STAR Reconciliation method has a number of requirements that must be met. The method must be able to make predictions for beginning of cycle (“BOC”) HZP total rod worth (“TRW”), total regulating bank worth (“RBW”), and MTC for the current cycle of the nuclear reactor. In addition, the method must have uncertainties based on plant benchmarks that are similar to the design code values since the basis for using analytical predictions in lieu of measurements to confirm safety analysis uncertainties for the design code is that the reconciliation method has similar accuracy as the design code. In one aspect, the method must consider the factors listed in Item 4 of Table 3-4 of WCAP-16011-P-A. In one aspect, the method must not rely on calculated data from the design code that has not been independently verified by a cycle specific measurement or by an independent qualified method. It is desirable that the alternate method allow reconciliation to be performed well before startup in case that reconciliation does not meet the criteria and thus a HZP rod worth and/or MTC measurement is necessary.

Accordingly, the alternate reconciliation approach provided by the present disclosure relies on empirical formulas based on a combination of calculated and measured data from past cycles of the nuclear reactor to provide a prediction of the cycle specific TRW, total RBW, and MTC at HZP BOC conditions. In various embodiments, all the parameters in the formulas are based on results from an unrodded cycle specific design code. This is an acceptable approach since the unrodded models are confirmed by measurement during the power ascension startup tests each cycle.

In various embodiments, the method provided herein is in the form of the three specific empirical formulas for TRW, total RBW and MTC, with the coefficients determined on a plant specific basis. The terms of these equations are all based on parameters calculated by the unrodded design model at nominal conditions. In various embodiments, uncertainties determined by plant specific benchmarks are also included.

### Example Implementation

Westinghouse has confirmed the validity of this method using data for a number (17) of cycles on a plant for which rod worth and MTC LPPT measurements were performed as well as for some later cycles (6) for which there were no measurements (post-STAR).

The measured data, associated core conditions, and unrodded flux distribution data were analyzed (using insights provided by basic reactor physics) to determine the major parameters which influence the MTC and rod worth and to develop empirical correlations that would allow implementation of the extrapolation method for STAR reconciliation. The parameters selected to fit were based on theoretical considerations, as well as the requirements set forth in the STAR topical. Regression fitting were used on the 17 measured cycles to determine a reasonable fit for TRW, RBW, and MTC. This fit was then used on all the 17 measured plus 6 unmeasured cycles to determine the uncertainty associated with the regression fits.

The present disclosure also allows for a neural network approach to model the TRW and MTC dependencies based on the identified key determining parameters. The neural network approach gave comparable, yet slightly larger, uncertainties. In one aspect, the cycle specific evaluation of the neural network approach requires developing and maintaining software routines (e.g. Excel Macros) to evaluate the neural network to obtain the cycle specific value. In one aspect, the neural network approach is in the form of a three layer neural network represented by a specific set of interconnecting node weights.

### HZP MTC

Development of an extrapolation method for the HZP MTC is relatively straight forward since there are very few global core wide parameters which have a strong influence on the MTC. A first parameter is Core Soluble Boron Concentration, upon which the MTC is highly dependent since a decrease in the moderator density also decreases the concentration of soluble absorber across the core.

A second parameter is Core Neutron Leakage, upon which the MTC is at least partially dependent since a decrease in the moderator density increases the mean free path of neutrons which makes the core more transparent to neutrons and thus increases core neutron leakage. For a high leakage core in which neutron leakage contributes a larger proportion to the core reactivity, a change in moderator density will result in a more negative MTC. For low leakage cores in which the neutron leakage is a smaller contribution to the core reactivity, a change in moderator density will have less impact on the MTC.

A third parameter is Core Fast to Thermal Flux Ratio, upon which the MTC is at least partially dependent. Cores with a higher fast to thermal flux ratio have a more negative MTC since there are more fast neutrons to moderate to the thermal energies that initiate U²³⁵ fissions. The fast to thermal flux ratio is primarily dependent on the core average enrichment and the core burnup.

A fourth parameter is Moderator Temperature, upon which the MTC is at least partially dependent since the change in moderator density associated with a change in temperature varies with temperature. However, in some embodiments, since the reconciliation is performed at the HZP temperature (565° F.), moderator temperature does not have to be included in the empirical formula.

Based on these considerations, the preliminary analysis of the 17 measured cycles indicates that the BOC HZP 565° F. all rods out (“ARO”) MTC could be reasonably represented by the following empirical formula:

MTC(pcm/° F.)=kₘ₀+kₘ₁L+kₘ₂φ_{1/2}+kₘ₃ppm+kₘ₄ppm²

where kₘ₀, kₘ₁, kₘ₂, kₘ₃, and kₘ₄ are constants derived from the plant specific data set, ppm is the soluble boron concentration (in parts per million) in the reactor coolant, φ_{1/2} is the core average fast to thermal flux ratio, and L is the core leakage in Δk units defined as:

$$L = \frac{Production / {k}_{eff}}{Removal} - 1 = \frac{\frac{{\int }_{V} v {\sum }_{f 1} {φ}_{1} + v {\sum }_{f 2} {φ}_{2} d V}{{k}_{eff}}}{{\int }_{V} v {\sum }_{a 1} {φ}_{1} + v {\sum }_{a 2} {φ}_{2} d V} - 1 = \frac{{k}_{∞}}{{k}_{eff}} - 1$$

where Σ_{fi} and Σₐᵢ are the fission and neutron absorption cross sections for neutron energy group i, (pi is the neutron flux for neutron energy group i, ν is the number of neutrons released per fission, k_{∞} and k_{eff} are the infinite and effective neutron multiplication factor for the reactor core, and V is the volume of the active core.

As an example, the following uncertainties based on actual plant measurements demonstrate the accuracy of predicting the MTC using this approach:
Bias: 0.084, StdDev: 0.271 pcm/° F., kσ: 0.631, UTL: 0.761 pcm/° F.

### Total CEA Worth

Unlike the MTC, the CEA worth is influenced by both global and local parameters since the CEAs are strong discrete absorbers located in a few specific locations within the core. Thus, the CEA worth will be highly influenced by the flux and reactivity distribution throughout the core. In this case, core neutronics perturbation methods can be used in lieu of detailed core flux calculations to estimate the CEA reactivity worth. The reactivity worth (ρ) of a change in local absorption δΣₐ is given by neutron perturbation theory as:

$$ρ = \frac{{\int }_{V , E} {φ}^{*} ( δ {\sum }_{a} ) φ dVdE}{{\int }_{V , E} {φ}^{*} v {\sum }_{f} φ dVdE}$$

where φ is the unperturbed flux, φ* is the adjoint unperturbed flux, Σ_{f} is the total fission cross section, ν is the number of neutrons released per fission, δΣₐ is the local change in total absorption cross section due to the presence of the control rod, and V is the volume of the active core.

Unfortunately, Westinghouse does not have a core design code capable of solving the 3D adjoint multigroup diffusion equation. However, noting that the one-group diffusion equation is self-adjoint, the equivalent one group perturbation equation can be written as:

$$ρ = - \frac{{\int }_{V} φ ( δ {\sum }_{a} ) φ dV}{{\int }_{V ,} φ v {\sum }_{f} φ dV}$$

where φ is the total (group 1+group 2) flux at the location of the CEA.

Note that if all the inserted CEA fingers are of the same design then the assembly average control rod group cross section can be approximated as:

δΣ_{1,i}∝Rᵢφ_{2/1,i}

where Ri is the number of CEA fingers inserted in assembly i, and φ_{2/1} is the thermal to assembly average fast flux ratio in assembly i at BOC, HZP, ARO.

Thus the control rod worth is roughly proportional to:

$$ρ ∝ {\sum }_{i = 1}^{N} {R}_{i} {φ}_{2 / 1 , i} {φ}_{i}^{2}$$

where φᵢ is the assembly average total flux in assembly i at BOC, HZP, ARO, and N is the total number of assemblies in the core.

Although the above equation reasonably captures the flux distribution impact on total CEA worth, it does not capture the impact of changes in neutron spectrum and neutron mean free path which also have a significant impact on the CEA worth. These effects can reasonably be captured by including the thermal to fast neutron flux ratio and moderator temperature and soluble boron concentration in the correlation. In one aspect, the moderator temperature can be eliminated from consideration for HZP conditions since it remains constant from cycle to cycle.

Note that the perturbation approach above assumes that the incremental change in absorptions does not result in a significant change in the core unperturbed flux distribution. This is approximately true for the total rod worth since almost every assembly contains a CEA and thus the overall core flux distribution with control rod inserted does not significantly change when all CEAs are inserted. But, in some embodiments, it is certainly not true for the case when only a few CEAs are inserted where the CEA insertion results in significant redistribution of the core flux distribution.

In some aspects, the total rod worth is dependent on the moderator density since the moderator density affects the neutron mean free path and thus how many neutrons actually get absorbed by the control rod. However, in various embodiments, since reconciliation is performed at the HZP temperature (565° F.) it does not have to be included in the formula.

Based on these considerations, regression analysis of the 17 measured cycles indicates that the BOC HZP 565° F. TRW for Ag—In—Cd tipped CEAs can be reasonable represented by the following empirical formula:

$$T R W ( p c m ) = {k}_{T R 0} + {k}_{T R 1} ppm + {k}_{T R 2} {ppm}^{2} + {k}_{T R 3} {\sum }_{i = 1}^{N} {R}_{i} {φ}_{2 / 1 , i} {φ}_{i}^{2}$$

where k_{TR0}, k_{TR1}, k_{TR2}, and k_{TR3} are constants derived from the plant specific data set, ppm is the soluble boron concentration (in parts per million) in the reactor coolant, and φ_{2/1} is the core average thermal to fast flux ratio at BOC, HZP, ARO, φᵢ is the neutron flux for neutron energy group i, and Ri is the number of CEA fingers inserted in assembly i.

As an example, the following uncertainties based on actual plant measurements demonstrate the accuracy of predicting the Total Control Rod Worth using this approach:
Bias: −0.01%, StdDev: 0.75%, kσ: 1.75%, LTL: −1.76%

### Total Regulating CEA Worth

As referenced above, in some aspects, the assumption of no significant change in the unperturbed flux distribution is not true for cases when only a few CEAs are inserted, where the CEA insertion results in significant redistribution of the core flux distribution. Thus, in various embodiments, the correlation for Regulating Bank worth contains additional terms related to the redistribution of the core flux when the sparsely distributed CEAs are inserted. In some embodiments, analysis of the data plus insights from basic reactor physics indicates that the appropriate correction terms are higher order perturbation terms (which has the effect of reducing the rod worth due to reduction of flux in the rodded assembly) and core average migration length and k_{∞} ratios of unrodded to rodded assemblies which has a significant effect on the flux redistribution.

The correlation for the regulating bank worth (RBW) for Ag—In—Cd tipped CEAs at BOC HZP 565° F. based on data from the 17 measured cycles is:

$$R B W ( p c m ) = {k}_{R R 0} + {k}_{R R 1} ppm + {k}_{R R 2} {ppm}^{2} + {k}_{R R 3} M + {k}_{R R 4} {M}^{2} + {k}_{R R 5} \frac{{k}_{ur}}{{k}_{r}} + {{k}_{R R 6} ( \frac{{k}_{ur}}{{k}_{r}} )}^{2} + {k}_{R R 7} ( {\sum }_{i = 1}^{N} {R}_{i} {φ}_{2 / 1 , i} {φ}_{i}^{2} ) + {{k}_{R R 8} ( {\sum }_{i = 1}^{N} {R}_{i} {φ}_{2 / 1 , i} {φ}_{i}^{2} )}^{2}$$

where where k_{RR0}, k_{RR1}, k_{RR2}, k_{RR3}, k_{RR4}, k_{RR5}, k_{RR6}, k_{RR7}, and k_{RR8} are constants derived from the plant specific data set and kᵤᵣ/kᵣ is the ratio of average unrodded k_{∞} in unrodded to rodded locations defined as:

$$\frac{{k}_{ur}}{{k}_{r}} = \frac{{\sum }_{i = 1}^{N} {k}_{i}}{{\sum }_{i = 1}^{N} Δ {k}_{rf} {R}_{i} {k}_{i}} - 1$$

where kᵢ is the unrodded k_{∞} in assembly i, Rᵢ is the number of regulating bank rod fingers inserted in assembly i, and Δk_{rf} is worth of one control rod finger. M is the total unrodded neutron migration length defined as:

$$M = \sqrt{\frac{{D}_{2}}{{\sum }_{a 2}} + \frac{{D}_{1}}{{\sum }_{a 1} + {\sum }_{r 1}}}$$

where Dᵢ and Σₐᵢ are the Diffusion constant and macroscopic absorption cross section for neutron energy group I, respectively, and Σr₁ is the macroscopic group 1 neutron removal cross section.

Note that the regulating rod worth is also dependent on the moderator density. In various embodiments, since the reconciliation will be performed at the HZP temperature (565° F.), it does not have to be included in the formula.

As an example, the following uncertainties based on actual plant measurements demonstrate the accuracy of predicting the Regulating Control Rod Worth using this approach:
Bias: −0.02%, StdDev: 1.60%, kσ: 3.61%, LTL: −3.64%

### STAR Reconciliation Criteria

WCAP-16011-P-A requires that the criteria for reconciliation be “The criteria for the reconciliation must be no greater than the corresponding uncertainties established for CEA worth and isothermal temperature coefficient (“ITC”) from benchmarking. This reconciliation may be performed by determining if the difference in the predicted value of the parameter between the two cores is consistent with the corresponding difference using a different core design method provided both methods are benchmarked in accordance with Core Design Applicability Requirement #3.

Note that the reconciliation actually compares the difference in change in rod worth (ΔTRW, ΔRBW) and MTC (ΔMTC) between the current cycle and a previous measured reference cycle calculated by the two methods. Comparing the differences between cycles rather than directly comparing the current cycle design predictions of rod worth and MTC and differences predicted by the reconciliation method eliminates any method-specific systematic bias from the comparison, leaving only the variance to affect the reconciliation comparison. The bias has been shown to have greater variability between different plants and fuel types than the variance. In some aspects, the chosen reference cycle should be one with a small measured-prediction (M-P) difference. In various embodiments, the same reference cycle is selected for both methods.

The reconciliation criteria is based on a two-sided 95/95 uncertainty associated with the difference between two independent predictions of the difference between TRW and MTC of the current and reference cycles. Because the STAR reconciliation is performed on the Δ difference, the appropriate reconciliation variance (denoted below as “σ²Recon”) will be twice the sum of the variances of the two methods used for reconciliation (“σ²Dcode” for the design code and “σ²_{RAlt}” for the alternate reconciliation method). Thus the standard deviation (a), for the reconciliation comparison becomes:

S_{Recon}=σ_{Recon}²=2*(σ_{Dcode}²+σ_{RAlt}²)

Since the reconciliation is based on 95/95 statistics, the reconciliation criteria is computer from:

kS_{Recon}=kσ_{Recon}²=2*(kσ_{Dcode}²+kσ_{RAlt}²)

The final reconciliation criteria is then established as the smaller of 1) the calculated 95/95 two-sided tolerance (K*σRecon), where “k” is the tolerance critical value for the number of data samples, or 2) the safety analysis (k_{95/95}σ) uncertainties.

Some key notes on the values used in this calculation. In one embodiment, the variance used for the design code is the variance from the set of benchmarks used to validate the uncertainties used in the safety analysis. The set of benchmarks can contain benchmarks for other plants if poolability is demonstrated. A rigorous calculation of S_{Recon} considers the variance for the reconciliation code. However, when considering only the design code variance, if S_{Recon} is larger than the safety analysis uncertainties, the final reconciliation criterion will not change regardless of the reconciliation method uncertainty. In one embodiment, for the situation in which reconciliation code benchmarks is not in compliance with the range of the design code benchmarks or if the reconciliation method uncertainty is unknown/not available (e.g., if a non-design method is to be used as the reconciliation method), then the reconciliation code variance should be conservatively set to zero when determining the reconciliation criteria.

Note that the procedures for some STAR implementations define a review criterion for the reconciliation comparison which, if exceeded, would prompt a review of both the design and reconciliation cycle specific calculations. This value is calculated in the same way as the reconciliation acceptance criteria except that the variances used are based only on current plant benchmarks. Exceeding the reconciliation review criterion initially (prior to follow-up investigation) does not automatically require that rod worth measurements be performed for the current cycle.

As an example, based on the above, the reconciliation criteria for ΔTRW, ΔRBW, and ΔMTC at BOC HZP is:

kσ_{ΔTRW}=\sqrt{2*(σ_{Dcode}²+σ_{RAlt}²)}=\sqrt{2*(8.5²+1.8²)}=12.2%>8.5%→8.5%

kσ_{ΔRRW}=\sqrt{2*(σ_{Dcode}²+σ_{RAlt}²)}=\sqrt{2*(8.5²+3.6²)}=13.1%>8.5%→8.5%

kσ_{ΔMTC}=\sqrt{2*(σ_{Dcode}²+σ_{RAlt}²)}=\sqrt{2*(1.6²+0.631²)}=2.43pcm/° F.>1.6pcm/° F.→1.6pcm/° F.

Note that an alternate approach for reconciliation described by the present disclosure assumes that the unrodded fluxes predicted by the design code have an uncertainty equivalent to that used in the benchmark cases used to establish the power distribution uncertainties. However, this assumption is confirmed during the power ascension physics tests at the 70% and 100% plateau which requires that the Root Mean Square (RMS) of the differences between the measured and predicted radial RPD for each fuel assembly is less than or equal to 5%.

For the purposes of STAR reconciliation, the RMS can be computed based on untilted octant symmetric power distributions since core tilts have no impact on the MTC, total, and total regulating bank worth. Also for STAR reconciliation purposes, it is only necessary to pass the test at near BOC conditions at any power level. In one aspect, it is conservative to use the results of the current test which bases the RMS comparison on the actual measured power distribution including any measured tilts.

### Example Implementation Summary

Based on the above, the disclosed STAR reconciliation procedure requires generating two sets of cycle specific best estimate predictions for the HZP MTC, HZP Total Rod worth, and HZP Total Regulating Bank worth using a design code, and using the alternate method empirical formulas for both the current cycle and a reference measured cycle. The assembly flux values used in the formulas are obtained from HZP ARO calculation by the design code.

The reconciliation is performed by comparing the difference in rod worth and ITC between the current cycle and the reference measured cycle calculated by the two methods. The STAR reconciliation requires that the two predictions agree to within the uncertainty used in the Safety Analysis calculations.

The alternate reconciliation procedure also requires that the design code power distribution meet the power ascension criteria of that the Root Mean Square (RMS) of the differences between the octant symmetric measured and predicted assembly power for each fuel assembly be less than or equal to 5% at any power and burnup prior to achieving hot full power (“HFP”) equilibrium conditions. Note that this is automatically confirmed by meeting the power ascension test criteria on rms assembly M-P required during the power ascension startup tests.

Note that this approach is in compliance with the reconciliation requirements of of the STAR Topical (WCAP-16011-P-A) since all the factors described by the STAR topical for the Extrapolation Method is explicitly considered in the development of the unrodded design model from which the assembly fluxes used in this method is based, the method has been benchmarked to plant measurements and uncertainties have been determined, and a reconciliation criteria has been developed that is within the combined uncertainty of the two reconciliation methods but no greater than the uncertainty used in the safety analysis.

The correlations developed according to the above method are applicable to all cycles with characteristics relative to the reference cycles within that defined in Items 3 and 4 of the STAR Applicability Criteria (Table 3-4 of WCAP-16011-P-A) and using.

While the foregoing disclosure is provided in connection with eliminating the LPPT using the STAR method, it should be understood that the present disclosure could also be applied for reconciliation required by the application of the Alternate Rod Worth Verification (ARWV) method for eliminating rod worth testing for W-NSSS plants. Thus, the present disclosure provides a way of justifying elimination of LPPT tests in both CE-NSSS and W-NSSS and reducing the risks associated with performing the tests under non-standard plant operating conditions.

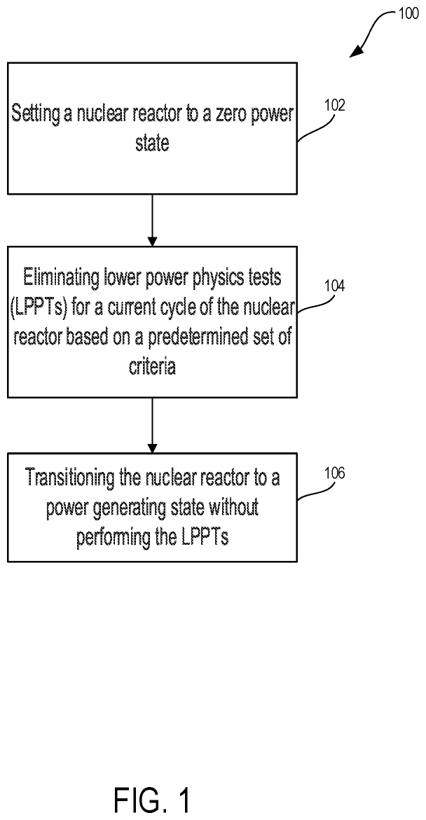

Referring now to FIG. 1, a method 100 for transitioning a nuclear reactor during initial cycle startup to a power generating state is provided, according to at least one aspect of the present disclosure. In various embodiments, the method 100 comprises setting 102 the nuclear reactor to a zero power state, such as a HZP state.

In various embodiments, the method 100 further includes eliminating 104 lower power physics tests (LPPTs) for a current cycle of the nuclear reactor based on a predetermined set of criteria. In various embodiments, the set of criteria can be criteria established by the STAR and ARWV methodologies, as described elsewhere herein. In various embodiments, the set of criteria can be criteria established by WCAP-16011-P-A, as described elsewhere herein.

In various embodiments, eliminating 104 the lower power physics tests (LPPTs) can comprise first predicting, using a first design code, a first set of values for factors of the LPPTs.

In various embodiments, the factors of the LPPTs can be MTC, total RBW, or TRW, as examples. In various embodiments, the first design code can be any code that is approved to make design code predictions for the factors of the LPPTs.

In various embodiments, eliminating 104 the lower power physics tests (LPPTs) can further comprise developing, using data from past cycles of the nuclear reactor, empirical formulas for the factors of the LPPTs. As described elsewhere herein, empirical formulas for MTC, total RBW, and TRW can be established based on data from past cycles of the nuclear reactor. In various embodiments, the data from the past cycles comprises unrodded cycle specific data. In various embodiments, developing the empirical formulas comprises applying a regression fit to the data from the past cycles of the nuclear reactor, as described elsewhere herein, to determine a reasonable fit for the LPPTs factors.

In various embodiments, eliminating 104 the lower power physics tests (LPPTs) can further comprise predicting, using the empirical formulas, a second set of values for the factors of the LPPTs. As described elsewhere herein, the second predictions can be made using the developed empirical formulas, which thus provides an independent alternate prediction to justify elimination of the LPPT.

In various embodiments, eliminating 104 the lower power physics tests (LPPTs) can further comprise reconciling the first values with the second values. In various embodiments, reconciling the first values with the second values comprises calculating a difference between the first values of the current cycle to first reference values from a reference cycle of the nuclear reactor and calculating a difference between the second values of the current cycle to second reference values from the reference cycle of the nuclear reactor. As described elsewhere herein, the reconciliation can require that two predictions agree to within the uncertainty used in the assessment calculations.

In various embodiments, the method 100 further includes transitioning 106 the nuclear reactor to the power generating state without performing the LPPTs, based on the reconciliation. As described elsewhere herein, if the two values of the predictions are reconciled, the STAR and ARWV methodologies allow for the LPPTs to be eliminated, thus reducing the startup testing time that is required prior to setting a nuclear reactor to the power generating state.

In various embodiments, the present disclosure provides a control system, such as a computer, a tablet, a smart phone, or the like, that includes a processor and a memory storing computer readable instructions, which, when executed by the processor, cause the processor to carry out the various functionality provided by the present disclosure. The control system can receive data, such as the data from past cycles of the nuclear reactor to develop the empirical formulas. The memory can store any amount of data, such as the data from past cycles or data from the reference cycle used for reconciliation, as examples.

The foregoing method and disclosure provides numerous advantages. The method provides a high accuracy method for predicting rod worth based on only data from the design model. The method uses the results of power ascension test results combined with considerations from basic reactor physics to determine whether control rod worth measurements are necessary.

The method provides several tests to determine whether the results of the power ascension measurements justify the elimination of the rod worth test irrespective of whether the normal power ascension tests have not met the criteria. The method does not require Tech Spec changes or license submittal. The method does not depend on a specific neutronics design code or methodology. The method can also been easily implemented by neural net machine learning.

Various aspects of the subject matter described herein are set out in the following examples.

Example 1—A method for transitioning a nuclear reactor during initial cycle startup to a power generating state, the method comprising setting the nuclear reactor to a zero power state, eliminating lower power physics tests (LPPTs) for a current cycle of the nuclear reactor based on a predetermined set of criteria, and transitioning the nuclear reactor to the power generating state without performing the LPPTs, based on the reconciliation. The current LPPTs are required to transition the nuclear reactor to the power generating state from the zero power state. The eliminating comprises predicting, using a first design code, a first set of values for factors of the LPPTs, developing, using data from past cycles of the nuclear reactor, empirical formulas for the factors of the LPPTs, predicting, using the empirical formulas, a second set of values for the factors of the LPPTs, and reconciling the first values with the second values.

Example 2—The method of Example 1, wherein the data from the past cycles comprises unrodded cycle specific data.

Example 3—The method of Examples 1 or 2, wherein developing the empirical formulas comprises applying a regression fit to the data from the past cycles of the nuclear reactor.

Example 4—The method of any one of Examples 1-3, wherein the eliminating of the LPPTs further comprises developing uncertainties associated with each empirical formula.

Example 5—The method of any one of Examples 1-4, wherein the factors comprise moderator temperature coefficient.

Example 6—The method of Example 5, wherein the empirical formula for moderator temperature coefficient is defined as:

MTC (pcm/° F.)=kₘ₀+kₘ₁L+kₘ₂φ_{1/2}+kₘ₃ ppm+kₘ₄ ppm²

where kₘ₀, kₘ₁, kₘ₂, kₘ₃, and kₘ₄ are constants derived from the plant specific data set, ppm is the soluble boron concentration (in parts per million) in the reactor coolant, φ_{1/2} is the core average fast to thermal flux ratio, and L is the core leakage in Δk units defined as:

$$L = \frac{Production / {k}_{eff}}{Removal} - 1 = \frac{\frac{{\int }_{V} v {\sum }_{f 1} {φ}_{1} + v {\sum }_{f 2} {φ}_{2} d V}{{k}_{eff}}}{{\int }_{V} v {\sum }_{a 1} {φ}_{1} + v {\sum }_{a 2} {φ}_{2} d V} - 1 = \frac{{k}_{∞}}{{k}_{eff}} - 1$$

where Σ_{fi} and Σₐᵢ are the fission and neutron absorption cross sections for neutron energy group i, φᵢ is the neutron flux for neutron energy group i, ν is the number of neutrons released per fission, k_{∞} and k_{eff} are the infinite and effective neutron multiplication factor for the reactor core, and V is the volume of the active core.

Example 7—The method of any one of Examples 1-6, wherein the factors comprise total rod worth.

Example 8—The method of Example 7, wherein the empirical formula for total rod worth is defined as:

$$T R W ( p c m ) = {k}_{T R 0} + {k}_{T R 1} ppm + {k}_{T R 2} {ppm}^{2} + {k}_{T R 3} {\sum }_{i = 1}^{N} {R}_{i} {φ}_{2 / 1 , i} {φ}_{i}^{2}$$

where k_{TR0}, k_{TR1}, k_{TR2}, and k_{TR3} are constants derived from the plant specific data set, ppm is the soluble boron concentration (in parts per million) in the reactor coolant, and φ_{2/1} is the core average thermal to fast flux ratio at BOC, HZP, ARO, φᵢ is the neutron flux for neutron energy group i, and Rᵢ is the number of CEA fingers inserted in assembly i.

Example 9—The method of any one of Examples 1-8, wherein the factors comprise total regulating bank worth.

Example 10—The method of Example 9, wherein the empirical formula for total regulating bank worth is defined as:

$$R B W ( p c m ) = {k}_{R R 0} + {k}_{R R 1} ppm + {k}_{R R 2} {ppm}^{2} + {k}_{R R 3} M + {k}_{R R 4} {M}^{2} + {k}_{R R 5} \frac{{k}_{ur}}{{k}_{r}} + {{k}_{R R 6} ( \frac{{k}_{ur}}{{k}_{r}} )}^{2} + {k}_{R R 7} ( {\sum }_{i = 1}^{N} {R}_{i} {φ}_{2 / 1 , i} {φ}_{i}^{2} ) + {{k}_{R R 8} ( {\sum }_{i = 1}^{N} {R}_{i} {φ}_{2 / 1 , i} {φ}_{i}^{2} )}^{2}$$

where where k_{RR0}, k_{RR1}, k_{RR2}, k_{RR3}, k_{RR4}, k_{RR5}, k_{RR6}, k_{RR7}, and k_{RR8} are constants derived from the plant specific data set and kᵤᵣ/kᵣ is the ratio of average unrodded k_{∞} in unrodded to rodded locations defined as:

$$\frac{{k}_{ur}}{{k}_{r}} = \frac{{\sum }_{i = 1}^{N} {k}_{i}}{{\sum }_{i = 1}^{N} Δ {k}_{rf} {R}_{i} {k}_{i}} - 1$$

where kᵢ is the unrodded k_{∞} in assembly i, Rᵢ is the number of regulating bank rod fingers inserted in assembly i, and Δk_{rf} is worth of one control rod finger. M is the total unrodded neutron migration length defined as:

$$M = \sqrt{\frac{{D}_{2}}{{\sum }_{a 2}} + \frac{{D}_{1}}{{\sum }_{a 1} + {\sum }_{r 1}}}$$

where Dᵢ and Σₐᵢ are the Diffusion constant and macroscopic absorption cross section for neutron energy group I, and Σr₁ is the macroscopic group 1 removal cross section.

Example 11—The method of any one of Examples 1-10, wherein reconciling the first values with the second values comprises calculating a difference between the first values of the current cycle to first reference values from a reference cycle of the nuclear reactor and calculating a difference between the second values of the current cycle to second reference values from the reference cycle of the nuclear reactor.

Example 12—A method for transitioning a nuclear reactor to a power generating state, the method comprising setting the nuclear reactor to a zero power state, eliminating lower power physics tests (LPPTs) for a current cycle of the nuclear reactor based on a predetermined set of criteria, transitioning the nuclear reactor to the power generating state without performing the LPPTs, based on the calculations. The current LPPTs are required to transition the nuclear reactor to the power generating state from the zero power state. The eliminating comprises predicting, using a first design code, a first set of values for factors of the LPPTs, wherein the factors comprise at least one of moderator temperature coefficient, total rod worth, and total regulating bank worth, developing, using data from past cycles of the nuclear reactor, empirical formulas for the factors of the LPPTs, predicting, using the empirical formulas, a second set of values for the factors of the LPPTs, calculating a difference between the first values of the current cycle to first reference values from a reference cycle of the nuclear reactor, and calculating a difference between the second values of the current cycle to second reference values from the reference cycle of the nuclear reactor.

Example 13—The method of Example 12, wherein the data from the past cycles comprises unrodded cycle specific data.

Example 14—The method of Examples 12 or 13, wherein developing the empirical formulas comprises applying a regression fit to the data from the past cycles of the nuclear reactor.

Example 15—The method of any one of Examples 12-14, wherein the eliminating of the LPPTs further comprises developing uncertainties associated with each empirical formula.

Example 16—The method of any one of Examples 12-15, wherein the empirical formula for moderator temperature coefficient is defined as:

MTC (pcm/° F.)=kₘ₀+kₘ₁L+kₘ₂φ_{1/2}+kₘ₃ ppm+kₘ₄ ppm²

where kₘ₀, kₘ₁, kₘ₂, kₘ₃, and kₘ₄ are constants derived from the plant specific data set, ppm is the soluble boron concentration (in parts per million) in the reactor coolant, φ_{1/2} is the core average fast to thermal flux ratio, and L is the core leakage in Δk units defined as:

$$L = \frac{P r oduction / {k}_{eff}}{Remo v a l} - 1 = \frac{\frac{{\int }_{V} v {\sum }_{f 1} {φ}_{1} + v {\sum }_{f 2} {φ}_{2} d V}{{k}_{eff}}}{{\int }_{V} v {\sum }_{a 1} {φ}_{1} + v {\sum }_{a 2} {φ}_{2} d V} - 1 = \frac{{k}_{∞}}{{k}_{eff}} - 1$$

where Σ_{fi} and Σₐᵢ are the fission and neutron absorption cross sections for neutron energy group i, φᵢ is the neutron flux for neutron energy group i, ν is the number of neutrons released per fission, k_{∞} and k_{eff} are the infinite and effective neutron multiplication factor for the reactor core, and V is the volume of the active core.

Example 17—The method of any one of Examples 12-16, wherein the empirical formula for total rod worth is defined as:

$$T R W ( p c m ) = {k}_{TR 0} + {k}_{TR 1} ppm + {k}_{TR 2} {ppm}^{2} + {k}_{TR 3} {\sum }_{i = 1}^{N} {R}_{i} {φ}_{2 / 1 , i} {φ}_{i}^{2}$$

where k_{TR0}, k_{TR1}, k_{TR2}, and k_{TR3} are constants derived from the plant specific data set, ppm is the soluble boron concentration (in parts per million) in the reactor coolant, and φ_{2/1} is the core average thermal to fast flux ratio at BOC, HZP, ARO, φᵢ is the neutron flux for neutron energy group i, and Ri is the number of CEA fingers inserted in assembly i.

Example 18—The method of any one of Examples 12-17, wherein the empirical formula for total regulating bank worth is defined as:

$$R B W ( p c m ) = \text{} {k}_{RR 0} + {k}_{RR 1} ppm + \text{} {k}_{RR 2} {ppm}^{2} + {k}_{RR 3} M + {k}_{RR 4} {M}^{2} + {k}_{RR 5} \frac{{k}_{ur}}{{k}_{r}} + {{k}_{RR 6} ( \frac{{k}_{ur}}{{k}_{r}} )}^{2} \text{} + {k}_{RR 7} ( {\sum }_{i = 1}^{N} {R}_{i} {φ}_{2 / 1 , i} {φ}_{i}^{2} ) + {{k}_{RR 8} ( {\sum }_{i = 1}^{N} {R}_{i} {φ}_{2 / 1 , i} {φ}_{i}^{2} )}^{2}$$

where where k_{RR0}, k_{RR1}, k_{RR2}, k_{RR3}, k_{RR4}, k_{RR5}, k_{RR6}, k_{RR7}, and k_{RR8} are constants derived from the plant specific data set and kᵤᵣ/kᵣ is the ratio of average unrodded k_{∞} in unrodded to rodded locations defined as:

$$\frac{{k}_{ur}}{{k}_{r}} = \frac{{\sum }_{i = 1}^{N} {k}_{i}}{{\sum }_{i = 1}^{N} Δ {k}_{rf} {R}_{i} {k}_{i}} - 1$$

where kᵢ is the unrodded k_{∞} in assembly i, Rᵢ is the number of regulating bank rod fingers inserted in assembly i, and Δk_{rf} is worth of one control rod finger. M is the total unrodded neutron migration length defined as:

$$M = \sqrt{\frac{{D}_{2}}{{\sum }_{a 2}} + \frac{D 1}{{\sum }_{a 1} + {\sum }_{r 1}}}$$

where Dᵢ and Σₐᵢ are the Diffusion constant and macroscopic absorption cross section for neutron energy group I, and Σr₁ is the macroscopic group 1 removal cross section.

While several forms have been illustrated and described, it is not the intention of Applicant to restrict or limit the scope of the appended claims to such detail. Numerous modifications, variations, changes, substitutions, combinations, and equivalents to those forms may be implemented and will occur to those skilled in the art without departing from the scope of this disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

The foregoing detailed description has set forth various forms of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor including one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a control circuit, a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T).

Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the foregoing disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc.

Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

The term “substantially”, “about”, or “approximately” as used in the present disclosure, unless otherwise specified, means an acceptable error for a particular value as determined by one of ordinary skill in the art, which depends in part on how the value is measured or determined. In certain embodiments, the term “substantially”, “about”, or “approximately” means within 1, 2, 3, or 4 standard deviations. In certain embodiments, the term “substantially”, “about”, or “approximately” means within 50%, 20%, 5%1, 10%, 9%, 8%, 7%, 6%, 5%, 4%, 3%, 2%, 1%, 0.5%, or 0.05% of a given value or range.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A method for transitioning a nuclear reactor during initial cycle startup to a power generating state, the method comprising:
setting the nuclear reactor to a zero power state;
eliminating lower power physics tests (LPPTs) for a current cycle of the nuclear reactor based on a predetermined set of criteria, wherein the current LPPTs are required to transition the nuclear reactor to the power generating state from the zero power state, and wherein the eliminating comprises:
predicting, using a first design code, a first set of values for factors of the LPPTs;
developing, using data from past cycles of the nuclear reactor, empirical formulas for the factors of the LPPTs;
predicting, using the empirical formulas, a second set of values for the factors of the LPPTs; and
reconciling the first values with the second values; and
transitioning the nuclear reactor to the power generating state without performing the LPPTs, based on the reconciliation.

2. The method of claim 1, wherein the data from the past cycles comprises unrodded cycle specific data.

3. The method of claim 1, wherein developing the empirical formulas comprises applying a regression fit to the data from the past cycles of the nuclear reactor.

4. The method of claim 1, wherein the eliminating of the LPPTs further comprises developing uncertainties associated with each empirical formula.

5. The method of claim 1, wherein the factors comprise moderator temperature coefficient.

6. The method of claim 5, wherein the empirical formula for moderator temperature coefficient is defined as:
MTC(pcm/° F.)=kₘ₀+kₘ₁L+kₘ₂φ_{1/2}+kₘ₃ ppm+kₘ₄ ppm²
where kₘ₀, kₘ₁, kₘ₂, kₘ₃, and kₘ₄ are constants derived from the plant specific data set, ppm is the soluble boron concentration (in parts per million) in the reactor coolant, φ_{1/2} is the core average fast to thermal flux ratio, and L is the core leakage in Δk units defined as:
$$L = \frac{P r oduction / {k}_{eff}}{Remo v a l} - 1 = \frac{\frac{{\int }_{V} v {\sum }_{f 1} {φ}_{1} + v {\sum }_{f 2} {φ}_{2} d V}{{k}_{eff}}}{{\int }_{V} v {\sum }_{a 1} {φ}_{1} + v {\sum }_{a 2} {φ}_{2} d V} - 1 = \frac{{k}_{∞}}{{k}_{eff}} - 1$$
where Σ_{fi} and Σₐᵢ are the fission and neutron absorption cross sections for neutron energy group i, φᵢ is the neutron flux for neutron energy group i, ν is the number of neutrons released per fission, k_{∞} and k_{eff} are the infinite and effective neutron multiplication factor for the reactor core, and V is the volume of the active core.

7. The method of claim 1, wherein the factors comprise total rod worth.

8. The method of claim 7, wherein the empirical formula for total rod worth is defined as:
$$T R W ( p c m ) = {k}_{TR 0} + {k}_{TR 1} ppm + {k}_{TR 2} {ppm}^{2} + {k}_{TR 3} {\sum }_{i = 1}^{N} {R}_{i} {φ}_{2 / 1 , i} {φ}_{i}^{2}$$
where k_{TR0}, k_{TR1}, k_{TR2}, and k_{TR3} are constants derived from the plant specific data set, ppm is the soluble boron concentration (in parts per million) in the reactor coolant, and φ_{2/1} is the core average thermal to fast flux ratio at BOC, HZP, ARO, φᵢ is the neutron flux for neutron energy group i, and Ri is the number of CEA fingers inserted in assembly i.

9. The method of claim 1, wherein the factors comprise total regulating bank worth.

10. The method of claim 9, wherein the empirical formula for total regulating bank worth is defined as:
$$RBW ( p c m ) = \text{} {k}_{RR 0} + {k}_{RR 1} ppm + \text{} {k}_{RR 2} {ppm}^{2} + {k}_{RR 3} M + {k}_{RR 4} {M}^{2} + {k}_{RR 5} \frac{{k}_{ur}}{{k}_{r}} + {{k}_{RR 6} ( \frac{{k}_{ur}}{{k}_{r}} )}^{2} \text{} + {k}_{RR 7} ( {\sum }_{i = 1}^{N} {R}_{i} {φ}_{2 / 1 , i} {φ}_{i}^{2} ) + {{k}_{RR 8} ( {\sum }_{i = 1}^{N} {R}_{i} {φ}_{2 / 1 , i} {φ}_{i}^{2} )}^{2}$$
where where k_{RR0}, k_{RR1}, k_{RR2}, k_{RR3}, k_{RR4}, k_{RR5}, k_{RR6}, k_{RR7}, and k_{RR8} are constants derived from the plant specific data set and kᵤᵣ/kᵣ is the ratio of average unrodded k_{∞} in unrodded to rodded locations defined as:
$$\frac{{k}_{ur}}{{k}_{r}} = \frac{{\sum }_{i = 1}^{N} {k}_{i}}{{\sum }_{i = 1}^{N} Δ {k}_{rf} {R}_{i} {k}_{i}} - 1$$
where kᵢ is the unrodded k_{∞} in assembly i, Rᵢ is the number of regulating bank rod fingers inserted in assembly i, and Δk_{rf} is worth of one control rod finger. M is the total unrodded neutron migration length defined as:
$$M = \sqrt{\frac{{D}_{2}}{{\sum }_{a 2}} + \frac{D 1}{{\sum }_{a 1} + {\sum }_{r 1}}}$$
where Dᵢ and Σₐᵢ are the Diffusion constant and macroscopic absorption cross section for neutron energy group I, and Σr₁ is the macroscopic group I removal cross section.

11. The method of claim 1, wherein reconciling the first values with the second values comprises:
calculating a difference between the first values of the current cycle to first reference values from a reference cycle of the nuclear reactor; and
calculating a difference between the second values of the current cycle to second reference values from the reference cycle of the nuclear reactor.

12. A method for transitioning a nuclear reactor to a power generating state, the method comprising:
setting the nuclear reactor to a zero power state;
eliminating lower power physics tests (LPPTs) for a current cycle of the nuclear reactor based on a predetermined set of criteria, wherein the current LPPTs are required to transition the nuclear reactor to the power generating state from the zero power state, and wherein the eliminating comprises:
predicting, using a first design code, a first set of values for factors of the LPPTs, wherein the factors comprise at least one of moderator temperature coefficient, total rod worth, and total regulating bank worth;
developing, using data from past cycles of the nuclear reactor, empirical formulas for the factors of the LPPTs;
predicting, using the empirical formulas, a second set of values for the factors of the LPPTs; and
calculating a difference between the first values of the current cycle to first reference values from a reference cycle of the nuclear reactor; and
calculating a difference between the second values of the current cycle to second reference values from the reference cycle of the nuclear reactor; and
transitioning the nuclear reactor to the power generating state without performing the LPPTs, based on the calculations.

13. The method of claim 12, wherein the data from the past cycles comprises unrodded cycle specific data.

14. The method of claim 12, wherein developing the empirical formulas comprises applying a regression fit to the data from the past cycles of the nuclear reactor.

15. The method of claim 12, wherein the eliminating of the LPPTs further comprises developing uncertainties associated with each empirical formula.

16. The method of claim 12, wherein the empirical formula for moderator temperature coefficient is defined as:
MTC(pcm/° F.)=kₘ₀+kₘ₁L+kₘ₂φ_{1/2}+kₘ₃ ppm+kₘ₄ ppm²
where kₘ₀, kₘ₁, kₘ₂, kₘ₃, and kₘ₄ are constants derived from the plant specific data set, ppm is the soluble boron concentration (in parts per million) in the reactor coolant, φ_{1/2} is the core average fast to thermal flux ratio, and L is the core leakage in Δk units defined as:
$$L = \frac{P r oduction / {k}_{eff}}{Remo v a l} - 1 = \frac{\frac{{\int }_{V} v {\sum }_{f 1} {φ}_{1} + v {\sum }_{f 2} {φ}_{2} d V}{{k}_{eff}}}{{\int }_{V} v {\sum }_{a 1} {φ}_{1} + v {\sum }_{a 2} {φ}_{2} d V} - 1 = \frac{{k}_{∞}}{{k}_{eff}} - 1$$
where Σ_{fi} and Σₐᵢ are the fission and neutron absorption cross sections for neutron energy group i, φᵢ is the neutron flux for neutron energy group i, ν is the number of neutrons released per fission, k_{∞} and k_{eff} are the infinite and effective neutron multiplication factor for the reactor core, and V is the volume of the active core.

17. The method of claim 12, wherein the empirical formula for total rod worth is defined as:
$$TRW ( p c m ) = {k}_{TR 0} + {k}_{TR 1} ppm + {k}_{TR 2} {ppm}^{2} + {k}_{TR 3} {\sum }_{i = 1}^{N} {R}_{i} {φ}_{2 / 1 , i} {φ}_{i}^{2}$$
where k_{TR0}, k_{TR1}, k_{TR2}, and k_{TR3} are constants derived from the plant specific data set, ppm is the soluble boron concentration (in parts per million) in the reactor coolant, and φ_{2/1} is the core average thermal to fast flux ratio at BOC, HZP, ARO, φᵢ is the neutron flux for neutron energy group i, and Ri is the number of CEA fingers inserted in assembly i.

18. The method of claim 12, wherein the empirical formula for total regulating bank worth is defined as:
$$RBW ( pc m ) = \text{} {k}_{RR 0} + {k}_{RR 1} ppm + \text{} {k}_{RR 2} {ppm}^{2} + {k}_{RR 3} M + {k}_{RR 4} {M}^{2} + {k}_{RR 5} \frac{{k}_{ur}}{{k}_{r}} + {{k}_{RR 6} ( \frac{{k}_{ur}}{{k}_{r}} )}^{2} \text{} + {k}_{RR 7} ( {\sum }_{i = 1}^{N} {R}_{i} {φ}_{2 / 1 , i} {φ}_{i}^{2} ) + {{k}_{RR 8} ( {\sum }_{i = 1}^{N} {R}_{i} {φ}_{2 / 1 , i} {φ}_{i}^{2} )}^{2}$$
where where k_{RR0}, k_{RR1}, k_{RR2}, k_{RR3}, k_{RR4}, k_{RR5}, k_{RR6}, k_{RR7}, and k_{RR8} are constants derived from the plant specific data set and kᵤᵣ/kᵣ is the ratio of average unrodded k_{∞} in unrodded to rodded locations defined as:
$$\frac{{k}_{ur}}{{k}_{r}} = \frac{{\sum }_{i = 1}^{N} {k}_{i}}{{\sum }_{i = 1}^{N} Δ {k}_{rf} {R}_{i} {k}_{i}} - 1$$
where kᵢ is the unrodded k_{∞} in assembly i, Rᵢ is the number of regulating bank rod fingers inserted in assembly i, and Δk_{rf} is worth of one control rod finger. M is the total unrodded neutron migration length defined as:
$$M = \sqrt{\frac{{D}_{2}}{{\sum }_{a 2}} + \frac{D 1}{{\sum }_{a 1} + {\sum }_{r 1}}}$$
where Dᵢ and Σₐᵢ are the Diffusion constant and macroscopic absorption cross section for neutron energy group I, and Σr₁ is the macroscopic group I removal cross section.
